(19) United States
(12) Patent Application Publication
(10) Pub. No.: US 2016/0171410 A1
(43) Pub. Date: Jun. 16, 2016

(54) INFRASTRUCTURE INVESTMENT PLANNING FOR BOTH SHORT-TERM AND LONG-TERM CAPACITY DEMANDS

(71) Applicants: Gufei SUN, Shanghai (CN); Heng WANG, Shanghai (CN); Yu CHENG, Shanghai (CN); Wen-Syan LI, Shanghai (CN)

(72) Inventors: Gufei SUN, Shanghai (CN); Heng WANG, Shanghai (CN); Yu CHENG, Shanghai (CN); Wen-Syan LI, Shanghai (CN)

(21) Appl. No.: 14/566,730

(22) Filed: Dec. 11, 2014

(51) Int. Cl. G06Q 10/06; G06Q 10/08; G06Q 30/02

(52) U.S. Cl. CPC G06Q 10/06315; G06Q 30/0202; G06Q 30/0206; G06Q 10/087

(57) ABSTRACT

Disclosed herein are technologies related to infrastructure investment planning for short-term and long-term capacity demands. One or more of the described technologies involve solving rent-or-buy optimization for real world infrastructure investment planning. Such technologies utilize forecasting, predictive analysis and dynamic programming. This Abstract is submitted with the understanding that it will not be used to interpret or limit the scope or meaning of the claims.

### TECHNICAL FIELD

The present disclosure relates generally to an infrastructure investment planning for both short-term and long-term capacity demands.

### BACKGROUND

Nearly all businesses require some form of business-related equipment to perform business functions. For example, a retail business may need point-of-sale registers, marketing displays, shelving and racks, cleaning equipment, and the like. An information technology business may need racks of computers (with storage), software, diagnostic equipment, and the like. A lawn-care business needs lawnmowers, edgers, string trimmers, leaf blowers, and the like. A manufacturing business needs various and several pieces of machinery for manufacturing, packaging, transportation, and delivery of raw materials and manufactured goods.

This necessary business equipment is part of the infrastructure of the business. The cost (e.g., financial) to acquire the business equipment is an investment in infrastructure of the business. Typically, a business must decide how to acquire its business equipment. The choice is typically to either purchase or lease the equipment.

When making decisions for investments in infrastructure, “rent” or “buy” is always a difficult question for decision makers. The rent-or-buy problem typically is a choice between paying a temporary cost, which may be repeating, for certain unit amount of services or goods and paying a “one-time” cost to acquire certain amount of services or goods for longer period of time. This problem could happen in many areas.

The classical form of this problem is known as ski-rental problem. The ski-rental problem is the name given to a class of problems in which there is a choice between continuing to pay a repeating cost or paying a one-time cost, which eliminates or reduces the repeating cost.

The basic version of the ski-rental problem may be described in this in this example: Isabel is going skiing for an unknown number of days. The exact number may be unknown for many various reasons (e.g., loss of interest, accidents that break a leg, or extremely bad weather). Assume that renting skis costs one dollar per day and buying skis costs ten dollars per day. Every day Isabel must decide whether to continue renting skis for one more day or buy a pair of skis. Of course, if Isabel knows in advance how many days she will go skiing, she can decide her minimum cost. For example, if Isabel will be skiing for more than ten days, it will be cheaper to buy skis. While if she will be skiing for fewer than ten days it will be cheaper to rent. If she will ski for exactly 10 days, then the choice is a toss-up. The question is what to do when Isabel does not know in advance how many days she will ski.

### SUMMARY

Technologies for infrastructure investment planning for short-term and long-term capacity demands are provided herein. One or more of the described technologies involve solving rent-or-buy optimization for real world infrastructure investment planning. Such technologies utilize forecasting, predictive analysis and dynamic programming.

With these and other advantages and features that will become hereinafter apparent, further information may be obtained by reference to the following detailed description and appended claims, and to the figures attached hereto.

### BRIEF DESCRIPTION OF THE DRAWINGS

FIG. 1 illustrates an exemplary process;

FIG. 2 illustrates an exemplary process; and

FIG. 3 illustrates an exemplary computing system to implement in accordance with the technologies described herein,

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed closed herein are technologies related to infrastructure investment planning for short-term and long-term capacity demands. Infrastructure investment planning may include a business-equipment acquisition plan. One or more of the described technologies involve solving rent-or-buy optimization for real world infrastructure investment planning. Such technologies utilize forecasting, predictive analysis and dynamic programming.

In real world, business-equipment acquisition problem is much more complex than the classic ski-rental problem. This is especially true when long-term considerations are taken into account, which is often part of a typical scenario of equipment-acquisition plan.

In such a scenario, a business requires some minimum amount of equipment to satisfy its business needs. In the real world, there so many more conditions and/or constraints that should be considered than those that factored. into the basic ski-rental problem. Firstly, rather than facing choices between rent and buy, a typically business must consider the customer capacity demands for its products and/or services and how such capacity demands can be fulfilled by purchased or rented business equipment. Secondly, the customer capacity demands (and thus, the business equipment needs) vary over time. Thirdly, the equipment will depreciate over time. Fourthly, the price of equipment will change over time. Lastly, there are also many detailed conditions to consider in order to achieve an optimal solution.

The technology described herein solves this kind of rent-or-buy optimization for the real world infrastructure investment planning problems. To achieve this, the technology utilizes techniques that include forecasting, predictive analysis and dynamic programming.

With forecasted capacity demands (given or calculated), the technology described herein generates a business-equipment acquisition plan by first optimizing an equipment purchase plan and then optimizing an equipment rental plan, where the rental plan covers the capacity demands not satisfied by the purchase plan. The rental plan leverages discounts offered by rental service providers to provide capacity flexibility as needed.

In the real world, the capacity demands of equipment usually are identical to the amount of service capacities provided by the equipment. The capacity demands of services can be varying over time. In recognition of this, the turbulence of capacity demands can be categorized into two categories, which are predictable and unpredictable changes.

As the name implies, a predictable change is a change in capacity demands that can be determined or predicted. Examples of predictable change in capacity demands includes one that that has a rising (or falling) trend over time. In addition, seasonal or cyclical changes are predictable. Typically, these kinds of changes can be predictable and describable by some capacity demands function and a set of parameters.

As for unpredictable change, as its name implies, it is a change in capacity demands that frustrates attempts to project its direction. These kinds of changes happen more randomly. While not predictable per se, most of the unpredictable capacity demands changes have certain kind of distribution pattern. This means that even though one cannot predict the exact time or amount of a specific change, one can still describe the change in a quantitative way.

Forecast of the capacity demands may be accomplished using predictive analytics. Predictive analytics encompasses a variety of statistical techniques from modeling, machine learning, and data mining that analyze current and historical facts to make predictions about future, or otherwise unknown, events (such as future capacity demands).

In business, predictive models exploit patterns found in historical and transactional data to identify risks and opportunities. Models capture relationships among many factors to allow assessment of risk or potential associated with a particular set of conditions, guiding decision making for candidate transactions.

Predictive analytics is an area of data mining that deals with extracting information from data (such as past capacity demands) and using it to predict trends and behavior patterns. Often the unknown event of interest is in the future, but predictive analytics can be applied to any type of unknown whether it is in the past, present or future. The core of predictive analytics relies on capturing relationships between explanatory variables and the predicted variables from past occurrences, and exploiting them to predict the unknown outcome.

Using predicted or quantifiable capacity demands, the technology described herein makes rent-or-buy decisions over time regarding the amount of capacity that should be fulfilled by purchasing equipment and the amount of capacity that should be fulfilled by renting equipment.

If one considers the rent-or-buy problem for longer time windows, the equipment price may change over time. In most cases, the price of equipment that provides certain amount of capacity usually has a decreasing trend. The change can be decreasing price of current equipment, or new equipment with higher capacity but sells at same or even lower price. These two cases are effectively identical because the cost to own unit amount of capacity is decreasing the same way.

Without loss of generality, this technology uses a predictive function calculate the price of unit capacity at certain time point. This is denoted herein as function P (t).

The purchased equipment will not last forever. At certain point of time, some of the equipment will be broken. This is called the depreciation. Typically, the lifetime of equipment is positively related to the MTBF (Mean Time between Failures), which is typically provided by the manufacturer. Once this parameter is known, an estimation of available inventory can be calculated after a certain period of time according to current inventory. Herein, this is denoted by function Iₜ^{m}=I^{m}(I₀^{m},t), where m denotes the model of the equipment. If there are multiple models of equipment, then Iₜ={Iₜ^{m}} is used to denote the array of inventory of each type of equipment. Once the inventory of each model of equipment is known, a future capacity prediction is calculated. That is, the future total capacity provided by all the equipment basing on current capacity. Herein, capacity (C, t) indicates this future capacity prediction.

Unlike the owned equipment, the capacity of rented equipment does not depreciate. Herein, Rₜ is used to denote the capacity provided by the rented equipment. It will depend on the rental order.

The time-varying capacity demands can be stored in a data structure as a sequence of capacity demands. The following is an example data structure for storing the timing-varying capacity demands at sequence of time points.

TABLE 1

| Column Name | Description |
|---|---|
| Time Point | The time point |
| Capacity demands | The amount of capacity demands at this time point |
| Variance | The confidence error of prediction |

The same as predicted capacity demands, the predicted price curve of equipment can be provided in the following example data structure format:

TABLE 2

| Column Name | Description |
|---|---|
| Time Point | The time point |
| Model | Unique model ID of certain type of equipment |
| Price | Unit price of this model of equipment at this time point |
| Variance | The confidence error of prediction |

Rental prices do not change as frequently as equipment prices. They will remain stable for a longer period of time, which makes it easier to predict the rental price of certain amount of capacity. However, the price of unit capacity for rental is greatly influenced by the amount of capacity and duration of rental time. This detailed condition leads to a further optimization chance as rental optimization. That is, this technology can utilize rentals to cover the gaps and variabilities not satisfied by the equipment purchases. Thus, the technology optimizes a plan for the equipment rentals to minimize the total rental cost.

As mentioned above, the rental price has different attributes as compared to the equipment price. The following is an example data, structure for storing rental-equipment property information.

TABLE 3

| Column Name | Description |
|---|---|
| Valid From Date | The start date of this price rule |
| Valid Until Date | The end date of this price rule |
| Unit Price | The unit price of service capacity |
| Minimal Amount | The minimal amount of capacity required to |
| | activate this price rule |
| Minimal Duration | The minimal duration of rent required to activate |
| | this price rule |

Aside from the time-varying equipment prices, equipment also have a set of attributes Which will affect the capacity it can provide as well as how long it will be available. The following is all example data structure to store equipment-attribute property information.

TABLE 4

| Column Name | Description |
|---|---|
| Model | Unique model ID of certain type of equipment |
| Capacity | Quantitative capacity of this type of equipment |
| MTBF | Mean time between failure, used to calculate |
| | depreciation of equipment |

While the above gives examples of the data that may be input into implementations of the technology described herein, the following represent examples of data structures of intermediate and/or final data generated by this technology.

The technology generates an equipment inventory curve. That is, a series of capacity determinations over time. This may be accomplished by plotting at, for example, regular intervals the quantitative capacity at a sequence of points in time.

Implementations of this technology generate an equipment purchase plan. The plan indicates what purchases (when and what amount) are needed to fulfill the determined or quantitative capacity. This may be accomplished by specifying the quantitative capacity of a purchase order and the specific time point for that purchase. The purchase plan does not provide details about the sourcing of equipment purchases. However, some implementations may incorporate that level of detail.

Implementations of this technology generate an equipment rental plan. The plan indicates what rental orders (when and what amount) are needed to fulfill the determined or quantitative capacity and the length of time of the indicated orders. This may be accomplished by specifying the quantitative capacity of a rental order and the specific time point for that rental and the length of time for that single order. The rental plan does not provide details about the sourcing of equipment rental. However, some implementations may incorporate that level of detail.

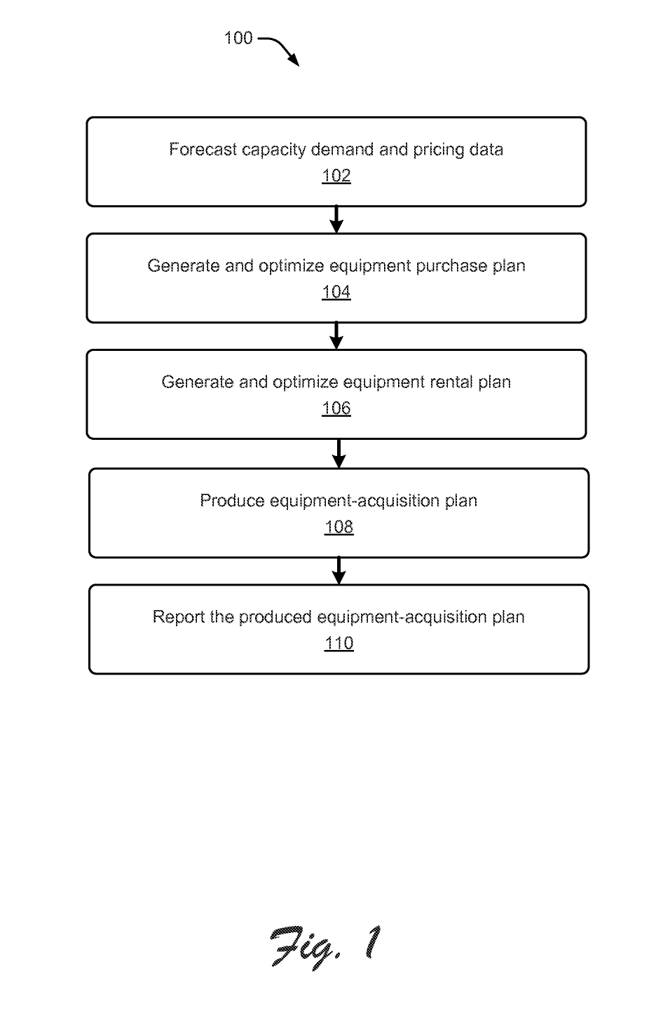

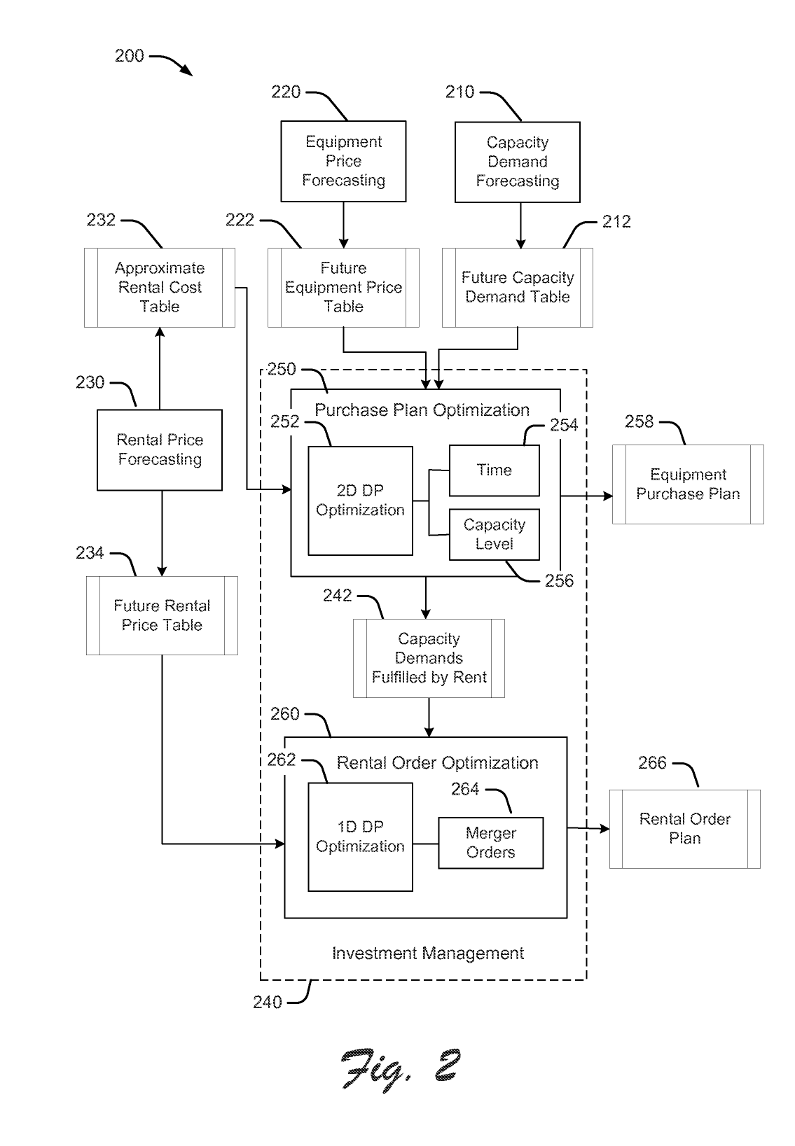

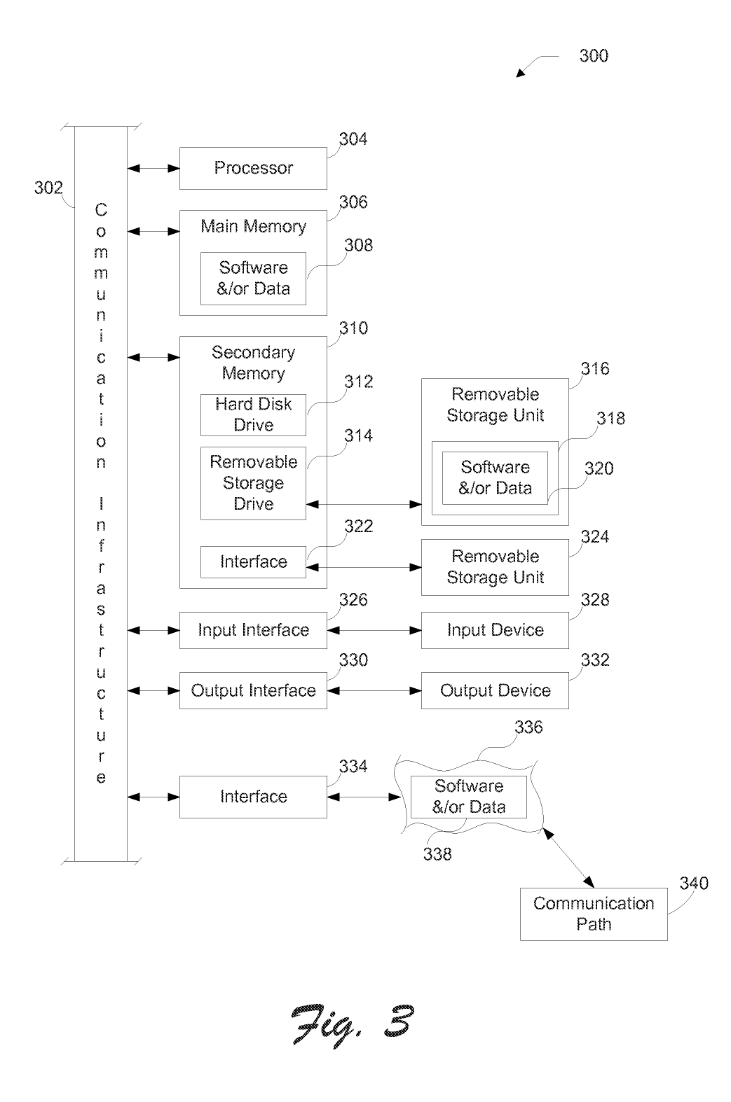

FIGS. 1 and 2 show example processes 100 and 200 for implementing the technology described herein. In particular, process 100 depicts an overview of a generation of an optimized equipment-acquisition plan. Process 200 depicts additional details of process 100. The processes 100 and 200 may be performed by a computing device or system (or groups thereof). An example architecture of such a computer device or system is described below with reference to FIG. 3.

Referring to FIG. 1, at 102, a computing system forecasts capacity demands and pricing data. The system predicts the capacity demands over time. In addition, the system estimates future prices for equipment purchases and rentals. Furthermore, approximate rental-costs are forecasted. More details of this action are explained further below with reference to FIG. 2.

At 104, the computing system generates and optimizes an equipment purchase plan based on the forecasted capacity demands and forecasted purchase prices. In addition, the forecasted approximate rental-costs are factored into the optimization. More details of this action are explained further below with reference to FIG. 2.

At 106, the computing system generates and optimizes an equipment rental plan based on forecasted rental prices and the capacity that the rented equipment must fulfill to meet the capacity demands not met by the purchased equipment.

At 108, the computing device produces an equipment-acquisition plan that is optimized for both equipment purchases and rentals to meet the anticipated capacity demands over time.

At 110, the computing device reports the optimized equipment-acquisition plan. A report may be generated via an output device and/or user interface. The report may be generated via screen, printed material, and the like. In addition, an automated order may be generated to purchase and/or rent the appropriate equipment in accordance with the optimized plan.

Process 200 of FIG. 2 shows more detail of many of the actions shown in process 100. In particular, the forecasting action 102 is shown in FIG. 2 as capacity demands forecasting action 210, future capacity demands table 212, equipment-price forecasting action 220, future equipment-price table 222, rental-price forecasting action 230, approximate rental-cost table 232, and future rental-price table 234.

The generation of the optimized equipment purchase plan and rental plans (of actions 104 and 105) are part of the infrastructure management block 240. The action 104 of generating the optimized equipment purchase plan is shown in FIG. 2 as purchase plan optimization 250, two-dimensional (2D) dynamic programming (DP) optimization 252, time dataset 254, capacity level dataset 256, capacity demands fulfilled by rent dataset 242, and equipment purchase plan 258. The action 106 of generating the optimized equipment rental plan is shown in FIG. 2 as rental order optimization 260, one-dimensional (1D) dynamic programming (DP) optimization 262, merge-orders dataset 264, and rental order plan 266. The combination of the equipment purchase plan 258 and the rental order plan 266 forms the equipment-acquisition plan produced by action 108 and reported by action 110.

With the discussion of process 200, presume that there is a time window (t₀, . . . , tₙ) in which costs are minimized to cover input capacity demands (Dₜ_{₀}, . . . , Dₜ_{ₙ}), like that provided by the future capacity demands table 212. There is a known or calculated initial capacity Cₜ_{₀}. The overall optimization solves this problem Cₜ_{ᵢ}+Rₜ_{ᵢ}≧Dₜ_{ᵢ} for ∀tᵢε[t₀, tₙ]. Rₜ_{ᵢ} is the gap between Cₜ_{ᵢ}=C(Iₜ_{ᵢ}) and Dₜ_{ᵢ} (where Iₜ_{ᵢ} is the inventory of purchased equipment at particular time point).

At 210 of process 200, the computer system forecasts capacity demands to generate the future capacity demands table 212. This is calculated based on predictable capacity demands. Alternatively, this forecast is based, at least in part, on unpredictable capacity demands that have a known or assumed distribution pattern. Thus, the capacity demands can be forecast in a quantifiable manner. The future capacity demands table 212 is a way of capturing the time-varying capacity demands as a sequence of predicted capacity demands.

At 220, the computer system forecasts purchase price of equipment. This generates the future equipment price table 222. The future equipment prices are calculated based on predictable or known price fluctuations. Alternatively, this forecast is based, at least in part, on unpredictable fluctuations that have a known or assumed distribution pattern. Thus, the prices changes can be forecast in a quantifiable manner. The future equipment price table 222 is a way of capturing the time-varying price changes as a sequence of predicted prices.

At 230, the computer system forecasts rental price of equipment. This generates the approximate rental cost table 232 and the future rental price table 234. Rental prices do not change as frequently as equipment prices. They will remain stable for a longer period of time, which makes it easier to predict the rental price of certain amount of capacity. However, the price of unit capacity for rental is greatly influenced by the amount of capacity and duration of rental time.

The future rental prices are calculated based on predictable or known price fluctuations. Alternatively, this forecast is based, at least in part, on unpredictable fluctuations that have a known or assumed distribution pattern. Thus, the price changes can be forecast in a quantifiable manner. The future rental price table 234 is a way of capturing the time-varying price changes as a sequence of predicted prices.

For each capacity level C if C>=Dₜ_{ₙ}, DP[tₙ][I]=0. Because the inventory equipment can cover the capacity demands, there is no further cost. If C<Dₜ_{ₙ}, then DP[tₙ][C]=rental_cost(Dₜ_{ₙ}−C). This rental_cost( ) is just an approximation. The average rental price can be used to calculate this approximate cost. These results are stored in the approximate-rental-cost table 232.

At 240, the investment management section (or alternatively, module or subsystem) includes the core optimization functions (or alternatively, modules or subsystems). In particular, those optimization functions include the purchase plan optimization 250 and the rental order optimization 260.

The purchase plan optimization 250 includes the two-dimensional (2D) dynamic programming (DP) optimization action 252 that takes the future capacity demands table 212, the future equipment price table 222, and the approximate rental cost table 232 as inputs. Based on capacity levels 256 at defined time points 254, the 2D DP optimization action 252 generates the equipment purchase plan 258, which represents the optimal plan for purchasing sufficient equipment so that the total inventory of purchased equipment may meet the forecasted capacity demands. The 2D DP Optimization action 252 also generates the capacity-demands-fulfilled-by-rent-dataset 242, which represents the difference between the forecasted capacity demands and the capacity provided by the total inventory of purchased equipment (in accordance with the equipment purchase plan).

In mathematics, computer science, economics, and bioinformatics, dynamic programming is a method for solving complex problems by breaking them down into simpler subproblems. It is applicable to problems exhibiting the properties of overlapping subproblems and optimal substructure. To do dynamic programming, subcomputations or subproblems that are performed more than once are identified. They are, instead, performed only once and the outputs are stored, typically in a table. A 2D DP approach uses a subproblem with 2D input.

Given an inventory of purchased equipment at time point Iₜ_{ᵢ}, the computer system can calculate cost to cover the capacity demands Dᵢ by filling the gap between Cₜ_{ᵢ}=C(Iₜ_{ᵢ}) and Dₜ_{ᵢ} with Rₜ_{ᵢ}. That is the cost of purchasing equipment to fill the gap between C(Iₜ_{ᵢ}) and Cₜ_{ᵢ} and the cost of Rₜ_{ᵢ}. The minimization function is denoted by cost(Iₜ_{ᵢ}).

The computer system calculates a minimum of the total cost Σₜ_{ᵢ}₌ₜ_{ₒ}^{t}^{ₙ} cost(iₜ_{ᵢ}) by choosing the suitable Iₜ_{ᵢ} (inventory of purchased. equipment) for each time point tᵢ. Each call of function cost( ) is also a process of minimizing. The minimal of the sum is not the sum of minimal of single cost.

The DP sub-problem of the 2D DP optimization action 252 may be described in this fashion. DP[t][C] denotes the minimal cost from t to the end of the time window with an initial inventory I providing capacity C at t. Therefore, the solution to the entire DP problem should be DP[t₀][Cₜ₀]. The solutions to the sub-problems are stored in a 2D-DP table DP[t][C].

With the 2D DP optimization action 252, the sub-problem is calculated backwards. The base case of sub-problem is DP [tₙ][C], which is the minimal cost of the last time point with different initial inventories. The initialization process will calculate DP[tₙ][C] for all possible initial inventories, where C ranges from min(Dₜ_{ᵢ}) to max(Dₜ_{₁}) for all i in [0, n]. In real world there is a minimal number of equipment in a purchase order, thus a step length for C can be defined.

Once the initialization process is finished, the solution of base case is expanded backwards to the solution of the entire DP problem. That means the DP problem becomes how to get DP[tᵢ₋₁][ . . . ] from DP[tᵢ][ . . . ], . . . , DP[tₙ][ . . . ]. For every time point, the cost for each the possible capacities is calculated.

To achieve this, a function cost(tᵢ, tⱼ, C) is defined to calculate the cost from tᵢ to tⱼ with initial inventory I providing capacity C at tᵢ, and from tᵢ to tⱼ, there are no new equipment purchased. Then if Cₜ<Dₜ for any t ε[tᵢ, . . . tⱼ], the rest capacity demands will be fulfilled with rental orders. Depreciation is considered. Because of that, Cₜ is changing even when no new equipment are purchased. The capacity function discussed above (with regard to the equipment inventory and capacity) may be used to calculate capacity provided by already-owned equipment for [tᵢ, . . . , tᵢ].

The following formula may be used to get DP[tᵢ₋₁][ . . . ] from DP[tᵢ][ . . . ], . . . , DP[tₙ][ . . . ]:

$$DP [ {t}_{i - 1} ] [ {C}_{1} ] = {min}_{i \leq j \leq n} ( rental\_cost ( [ {R}_{{t}_{i}} , … , {R}_{{t}_{j}} ] ) + {min}_{C} ( purchase\_cost ( C - capacity ( {C}_{1} , {t}_{j} - {t}_{i} ) ) + DP [ {t}_{j} ] [ C ] ) )$$

Here C₁ is one of the possible capacity levels at tᵢ₋₁. capacity (C₁, tⱼ−tᵢ) is the depreciated capacity at tⱼ. The purchase cost function will consider the price change of unit capacity as well.

Based on this formula, the following example pseudo code may be used to get DP[t₀][C₀]:

TABLE 5
Pseudo Code of DP Algorithm for Purchase Planning
Algorithm 1 Dynamic Algorithm for Purchase Planning

| | |
|---|---|
| 1: | FUNCTION DP_Purchase_Planning |
| 2: | BEGIN |
| 3: | DP Table DP[Nₜ][N_{C}] |
| 4: | FOR C IN [min(C), ... , max(C)] |
| 5: | IF C > Dₜ_{ₙ} |
| 6: | DP[tₙ][C] = 0 |
| 7: | ELSE |
| 8: | DP[tₙ][C] = rental_cost(Dₜ_{ₙ} − C). |
| 9: | END IF |
| 10: | END FOR |
| 11: | FOR t = tₙ₋₁ TO t₀ |
| 12: | FOR C IN [min(C), ... , max(C)] |
| 13: | $DP [ {t}_{i - 1} ] [ {C}_{l} ] = {min}_{i \leq j \leq n} ( rental\_cost ( [ {R}_{{t}_{i}} , … , {R}_{{t}_{j}} ] ) +$ |
| | ${min}_{C} ( purchase\_cost ( C - C ( {C}_{l} , {t}_{j} - {t}_{i} ) ) + DP [ {t}_{j} ] [ C ] ) )$ |
| 14: | END FOR |
| 15: | END FOR |
| 16: | END |

While calculating the DP table, the inner minimizing function will choose a capacity level at tⱼ for a given capacity level at tᵢ₋₁ In this way, multiple lists of capacities can be built for each capacity level at tᵢ₋₁. The list starting with C₀ at t₀ is chosen as the source of capacity curve mentioned above as part of the equipment inventory curve. The equipment purchase plan 258 is derived directly from the equipment inventory curve.

The rental order optimization 260 includes the one-dimensional D) dynamic programming (DP) optimization action 262 that takes the capacity-demands-fulfilled-by-rent dataset 242 and the future rental price table 234 as inputs. Because optimized rental order plan 266 is created to fill in the gaps not covered by the inventoried (purchased and already owned) equipment, the rental order optimization 260 is performed after the purchase plan optimization.

Given a time window (t₀, tₙ), and the capacity need to be fulfilled by rental at every time (Rₜ_{ₒ}, Rₜ_{ₙ}), which is represented in the capacity demands-fulfilled-by-rent dataset 242. The computer system merges the scattered rental deals to minimize the total rental cost. That is represented by the merge orders dataset 264. If cost Rₜ_{ᵢ} . . . Rₜ_{ᵢ})<ₜ₌ₜ_{ᵢ}^{t}^{ⱼ} cost(Rₜ), all rental orders from Rₜ_{ᵢ} to Rₜ_{ⱼ} are merged.

For the rental order optimization. DP[tᵢ] is defined as the minimal rental cost from tᵢ to tₙ. Thus, the minimal rental cost of the rental order plan 266 will be stored in DP[t₀].

Rental optimization is a 1-D DP problem. The formula to expand the solution is listed as follows:

$$DP [ {t}_{i - 1} ] = {min}_{{t}_{i} \leq {t}_{j} \leq {t}_{n}} ( rental\_cost ( {t}_{i} , {t}_{j} ) + DP [ {t}_{j} ] )$$

Different from the rental_cost function discussed above with regard to the forecasting of rental price forecasting 230, this function here will choose the best plan from the rental price table, and rental orders from tᵢ to tᵢ will merge into one order.

TABLE 6
Pseudo Code of DP Algorithm for Rental Order Planning
Algorithm 2 Dynamic Algorithm for Rental Order Planning

| | |
|---|---|
| 1: | FUNCTION DP_Rental_Planning |
| 2: | BEGIN |
| 3: | DP Table DP[Nₜ] |
| 4: | DP[tₙ] = rental_cost(tₙ) |
| 5: | FOR t = tₙ₋₁ TO t₀ |
| 6: | $DP [ {t}_{i - 1} ] = {min}_{{t}_{i} \leq {t}_{j} \leq {t}_{n}} ( rental\_cost ( {t}_{i} , {t}_{j} ) + DP [ {t}_{j} ] )$ |
| 7: | END FOR |
| 8: | END |

When calculating the DP table, every rental_cost(tᵢ, tⱼ) can be chosen and its rental planned accordingly. The list of recorded rental orders (which is the rental order plan 266) is the result of rental order optimization 260.

One or more implementations of the technology discussed herein may also be described as a process for system performing that process) that does at least the following actions: forecasting capacity demands over a defined time period, wherein the capacity demands are for services provided by equipment, the equipment having a defined service capacity; forecasting pricing data over the defined time period, the forecasted pricing data includes future equipment price dataset and future rental price dataset, the future equipment price dataset include estimated future prices for purchase of additional equipment over the defined time period and the future rental prices dataset include estimated future prices for rental orders of additional equipment over the defined time period; generating an optimized equipment purchase plan that includes indicators to purchase equipment having sufficient capacity to fulfill but not exceed the forecasted capacity demands over the defined time period; determining the remainder capacity demands that is not fulfilled by the equipment purchase in accordance with the optimized equipment purchase plan; generating an optimized rental order plan that includes indicators to order equipment rentals having sufficient capacity to at least fulfill the remainder capacity demands over the defined time period; producing an equipment-acquisition plan by combining the optimized equipment purchase plan and the optimized rental order plan; reporting the produced equipment-acquisition plan.

Other implementations may have one or more of these features: the forecasting of the capacity demands utilizes predictive analytics to determine future capacity demands over the time period; the defined capacity of purchased and rented equipment varies over the time period; forecasting an approximate rental cost over the time period based upon an average price for renting equipment; the generating of the optimized equipment purchase plan includes performing a two-dimensional dynamic programming function based, at least in part, on the forecasted capacity demands and the forecasted pricing data; the generating of the optimized rental order plan includes performing a one-dimensional dynamic programming function based, at least in part, on the remainder capacity demands and the forecasted pricing data; the optimized equipment purchase plan lists when to purchase equipment with sufficient capacity to fulfill but not exceed the forecasted capacity demands over the defined time period; the optimized rental order plan lists when to order rental equipment with sufficient capacity to at least fulfill the remainder capacity demands over the defined time period; the optimized rental order plan specifies duration of rental orders; the reporting includes generating of a user-interface to communicate to a user the produced equipment-acquisition plan.

One or more implementations of the technology discussed herein may also be described as a process (or system performing that process or a computer-readable media with instructions) that does at least the following actions: forecasting capacity demands over a defined time period, wherein the capacity demands are for services provided by equipment, the equipment having a defined service capacity, wherein the forecasting of the capacity demands utilizes predictive analytics to determine future capacity demands over the time period; forecasting pricing data over the defined time period, the forecasted pricing data includes future equipment price dataset and future rental price dataset, the future equipment price dataset include estimated future prices for purchase of additional equipment over the defined time period and the future rental prices dataset include estimated future prices for rental orders of additional equipment over the defined time period; generating an optimized equipment purchase plan that includes indicators to purchase equipment having sufficient capacity to fulfill but not exceed the forecasted capacity demands over the defined time period, wherein the generating of the optimized equipment purchase plan includes performing a two-dimensional dynamic programming function based, at least in part, upon the forecasted capacity demands and the forecasted pricing data; determining the remainder capacity demands that is not fulfilled by the equipment purchase in accordance with the optimized equipment purchase plan; generating an optimized rental order plan that includes indicators to order equipment rentals having sufficient capacity to at least fulfill the remainder capacity demands over the defined time period, wherein the generating of the optimized rental order plan includes performing a one-dimensional dynamic programming function based, at least in part, upon the remainder capacity demands and the forecasted pricing data; producing an equipment-acquisition plan by combining the optimized equipment purchase plan and the optimized rental order plan; reporting the produced equipment-acquisition plan.

Other implementations may have one or more of these features: the optimized equipment purchase plan lists when to purchase equipment with sufficient capacity to fulfill but not exceed the forecasted capacity demands over the defined time period; and the optimized rental order plan lists when to order rental equipment with sufficient capacity to at least fulfill the remainder capacity demands over the defined time period.

One or more implementations of the technology discussed herein may also be described as a process (or system performing that process) that does at least the following actions: forecasting capacity demands over a defined time period, wherein the capacity demands are for services provided by equipment, the equipment having a defined service capacity; forecasting pricing data over the defined time period, the forecasted pricing data includes future equipment price dataset and future rental price dataset, the future equipment price dataset includes estimated future prices for purchase of additional equipment over the defined time period and the future rental prices dataset includes estimated future prices for rental orders of additional equipment over the defined time period; generating an optimized equipment purchase plan that includes indicators to purchase equipment having sufficient capacity to fulfill but not exceed the forecasted capacity demands over the defined time period, the generating of the optimized equipment purchase plan is based, at least in part, on the forecasted capacity demands and the forecasted pricing data; determining the remainder capacity demands that is not fulfilled by the equipment purchase in accordance with the optimized equipment purchase plan; generating an optimized rental order plan that includes indicators to order equipment rentals having sufficient capacity to at least fulfill the remainder capacity demands over the defined time period, the generating of the optimized rental order plan is based, at least in part, on the remainder capacity demands and the forecasted pricing data; producing an equipment-acquisition plan by combining the optimized equipment purchase plan and the optimized rental order plan; executing the produced equipment-acquisition plan, wherein the executing of the produced equipment-acquisition plan includes automated submission of orders to purchase and/or rent equipment in accordance with the produced equipment-acquisition plan.

Other implementations may have one or more of these features: the forecasting of the capacity demands utilizes predictive analytics to determine future capacity demands over the time period; the defined capacity of purchased and rented equipment varies over the time period; forecasting an approximate rental cost over the time period based upon an average price for renting equipment; the generating of the optimized equipment purchase plan includes performing a two-dimensional dynamic programming function based, at least in part, upon the forecasted capacity demands and the forecasted pricing data, the generating of the optimized rental order plan includes performing a one-dimensional dynamic programming function based, at least in part, on the remainder capacity demands and the forecasted pricing data; the optimized equipment purchase plan lists when to purchase equipment with sufficient capacity to fulfill but not exceed the forecasted capacity demands over the defined time period.

FIG. 3 illustrates an exemplary system 300 that may implement, at least in part, the technologies described herein. The computer system 300 includes one or more processors or processor devices, such as processor 304. Processor 304 can be a special-purpose processor or a general-purpose processor. Processor 304 is connected to a communication infrastructure 302 (for example, a bus or a network). Depending upon the context, the computer system 300 may also be called a client device.

Computer system 300 also includes a main memory device 306, preferably Random Access Memory (RAM), containing possibly inter aha computer software and/or data 308.

Computer system 300 may also include a secondary memory device 310. Secondary memory device 310 may include, for example, a hard disk drive 312, a removable storage drive 314, a memory stick, etc. A removable storage drive 314 may comprise a floppy disk drive, a magnetic tape drive, an optical disk drive, a flash memory, or the like. A removable storage drive 314 reads from and/or writes to a removable storage unit 316 in a well-known manner. A removable storage unit 316 may comprise a floppy disk, a magnetic tape, an optical disk, etc. which is read by and written to by removable storage drive 314. As will be appreciated by persons skilled in the relevant art(s) removable storage unit 316 includes a computer usable storage medium 318 having stored therein possibly inter alia computer software and/or data 320.

In alternative implementations, secondary memory 310 may include other similar means for allowing computer programs or other instructions to be loaded into computer system 300. Such means may include, for example, a removable storage unit 324 and an interface 322. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 324 and interfaces 322 which allow software and data to be transferred from the removable storage unit 324 to computer system 300.

Computer system 300 may also include an input interface 326 and a range of input devices 328 such as, possibly inter alia, a keyboard, a mouse, etc.

Computer system 300 may also include an output interface 330 and a range of output devices 332 such as, possibly inter alia, a display, one or more speakers, etc.

Computer system 300 may also include a communications interface 334. Communications interface 334 allows software and/or data 338 to be transferred between computer system 300 and external devices. Communications interface 334 may include a modem, a network interface (such as an Ethernet card), a communications port, a Personal Computer Memory Card International Association (PCMCIA) slot and card, or the like. Software and/or data 338 transferred via communications interface 334 are in the form of signals 336 which may be electronic, electromagnetic, optical, or other signals capable of being received by communications 334. These signals 336 are provided to communications interface 334 via a communications path 340. Communications path 340 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 316, removable storage unit 324, and a hard disk installed in hard disk drive 312. Computer program medium and computer usable medium can also refer to memories, such as main memory 306 and secondary memory 310, which can be memory semiconductors (e.g. Dynamic Random Access Memory (DRAM) elements, etc.). These computer program products are means for providing software to computer system 300.

Computer programs (also called computer control logic) are stored in main memory 306 and/or secondary memory 310. Such computer programs, when executed, enable computer system 300 to implement the present technology described herein. In particular, the computer programs, when executed, enable processor 304 to implement the processes of aspects of the above. Accordingly, such computer programs represent controllers of the computer system 300. Where the technology described herein is implemented, at least in part, using software, the software may be stored in a computer program product and loaded into computer system 300 using removable storage drive 314, interface 322, hard disk drive 312 or communications interface 334.

The technology described herein may be implemented as computer program products comprising software stored on any computer useable medium. Such software, when executed in one or more data processing devices, causes data processing device(s) to operate as described herein. Embodiments of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Note that herein the discussion focuses on businesses and the customer capacity demands for the products/services of such businesses. However, the technology described herein may be utilized for non-commercial purposes. For example, a non-profit (e.g., a church or charity) can determine their equipment-acquisition plan based upon the capacity demands of those that they serve and/or those that contribute/volunteer to the non-profit. Similarly, a governmental entity (e.g., city, state, or national department) has capacity demands for their services which can benefit from an equipment-acquisition plan developed in accordance with the technology described herein.

What is claimed is:

1. A method comprising:
forecasting capacity demands over a defined time period, wherein the capacity demands are for services provided by equipment, the equipment having a defined service capacity;
forecasting pricing data over the defined time period, the forecasted pricing data includes future equipment price dataset and future rental price dataset, the future equipment price dataset includes estimated future prices for purchase of additional equipment over the defined time period and the future rental prices dataset includes estimated future prices for rental orders of additional equipment over the defined time period;
generating an optimized equipment purchase plan that includes indicators to purchase equipment having sufficient capacity to fulfill but not exceed the forecasted capacity demands over the defined time period;
determining the remainder capacity demands that are not fulfilled by the equipment purchase in accordance with the optimized equipment purchase plan;
generating an optimized rental order plan that includes indicators to order equipment rentals having sufficient capacity to at least fulfill the remainder capacity demands over the defined time period;
producing an equipment-acquisition plan by combining the optimized equipment purchase plan and the optimized rental order plan; and
reporting the produced equipment-acquisition plan.

2. The method according to claim 1, wherein the forecasting of the capacity demands utilizes predictive analytics to determine future capacity demands over the time period.

3. The method according to claim 1, wherein the defined capacity of purchased and rented equipment varies over the time period.

4. The method according to claim 1, further comprising forecasting an approximate rental cost over the time period based on an average price for renting equipment.

5. The method according to claim 1, wherein the generating of the optimized equipment purchase plan comprises performing a two-dimensional dynamic programming function based, at least in part, on the forecasted capacity demands and the forecasted pricing data.

6. The method according to claim 1, wherein the generating of the optimized rental order plan comprises performing a one-dimensional dynamic programming function based, at least in part, on the remainder capacity demands and the forecasted pricing data.

7. The method according to claim 1, wherein the optimized equipment purchase plan lists when to purchase equipment with sufficient capacity to fulfill but not exceed the forecasted capacity demands over the defined time period.

8. The method according to clan 1, wherein the optimized rental order plan lists when to order rental equipment with sufficient capacity to at least fulfill the remainder capacity demands over the defined time period.

9. The method according to claim 8, wherein the optimized rental order plan specifies duration of rental orders.

10. The method according to claim 1, wherein the reporting comprises generating of a user-interface to communicate to a user the produced equipment-acquisition plan.

11. One or more non-transitory computer-readable media storing processor-executable instructions that when executed cause one or more processors to perform operations comprising:
forecasting capacity demands over a defined time period, wherein the capacity demands are for services provided by equipment, the equipment having a defined service capacity, wherein the forecasting of the capacity demands utilizes predictive analytics to determine future capacity demands over the time period;
forecasting pricing data over the defined time period, the forecasted pricing data includes future equipment price dataset and future rental price dataset, the future equipment price dataset includes estimated future prices for purchase of additional equipment over the defined time period and the future rental prices dataset includes estimated future prices for rental orders of additional equipment over the defined time period;
generating an optimized equipment purchase plan that includes indicators to purchase equipment having sufficient capacity to fulfill but not exceed the forecasted capacity demands over the defined time period, wherein the generating of the optimized equipment purchase plan includes performing a two-dimensional dynamic programming function based, at least in part, on the forecasted capacity demands and the forecasted pricing data;
determining the remainder capacity demands that is not fulfilled by the equipment purchase in accordance with the optimized equipment purchase plan;
generating an optimized rental order plan that includes indicators to order equipment rentals having sufficient capacity to at least fulfill the remainder capacity demands over the defined time period, wherein the generating of the optimized rental order plan includes performing a one-dimensional dynamic programming function based, at least in part, on the remainder capacity demands and the forecasted pricing data;
producing an equipment-acquisition plan by combining the optimized equipment purchase plan and the optimized rental order plan; and
reporting the produced equipment-acquisition plan.

12. The one or more computer-readable media according to claim 11, wherein the optimized equipment purchase plan lists when to purchase equipment with sufficient capacity to fulfill but not exceed the forecasted capacity demands over the defined time period.

13. The one or more computer-readable media according to claim 11, wherein the optimized rental order plan lists when to order rental equipment with sufficient capacity to at least fulfill the remainder capacity demands over the defined time period.

14. A system for facilitating production of an optimized equipment-acquisition plan, comprising:
a non-transitory memory device for storing computer readable program code; and
a processor device in communication with the memory device, the processor device being operative with the computer readable program code to perform steps including
forecasting capacity demands over a defined time period, wherein the capacity demands are for services provided by equipment, the equipment having a defined service capacity,
forecasting pricing data over the defined time period, the forecasted pricing data includes future equipment price dataset and future rental price dataset, the future equipment price dataset includes estimated future prices for purchase of additional equipment over the defined time period and the future rental prices dataset includes estimated future prices for rental orders of additional equipment over the defined time period,
generating an optimized equipment purchase plan that includes indicators to purchase equipment having sufficient capacity to fulfill but not exceed the forecasted capacity demands over the defined time period, the generating of the optimized equipment purchase plan is based, at least in part, on the forecasted capacity demands and the forecasted pricing data,
determining the remainder capacity demands that is not fulfilled by the equipment purchase in accordance with the optimized equipment purchase plan,
generating an optimized rental order plan that includes indicators to order equipment rentals having sufficient capacity to at least fulfill the remainder capacity demands over the defined time period, the generating of the optimized rental order plan is based, at least in part, on the remainder capacity demands and the forecasted pricing data,
producing an equipment-acquisition plan by combining the optimized equipment purchase plan and the optimized rental order plan, and
executing the produced equipment-acquisition plan, wherein the executing of the produced equipment-acquisition plan includes automated submission of orders to purchase and/or rent equipment in accordance with the produced equipment-acquisition plan.

15. The system according to claim 14, wherein the forecasting of the capacity demands utilizes predictive analytics to determine future capacity demands over the time period.

16. The system according to claim 14, wherein the defined capacity of purchased and rented equipment varies over the time period.

17. The system according to claim 14, wherein the processor device is further operative with the computer readable program code to forecast an approximate rental cost over the time period based upon an average price for renting equipment.

18. The system according to claim 14, wherein the generating of the optimized equipment purchase plan comprises performing a two-dimensional dynamic programming function based, at least in part, on the forecasted capacity demands and the forecasted pricing data.

19. The system according to claim 14, wherein the generating of the optimized rental order plan comprises performing a one-dimensional dynamic programming function based, at least in part, on the remainder capacity demands and the forecasted pricing data.

20. The system according to claim 14, wherein the optimized equipment purchase plan lists when to purchase equipment with sufficient capacity to fulfill but not exceed the forecasted capacity demands over the defined time period.
